(19) United States
(12) Patent Application Publication
(10) Pub. No.: US 2012/0024876 A1
(43) Pub. Date: Feb. 2, 2012

(54) SEALED ENCLOSURE AND SYSTEM

(76) Inventors: David John GEER, Saint Mary's, PA (US); John T. Clark, Saint Mary's, PA (US)

(21) Appl. No.: 12/845,854

(22) Filed: Jul. 29, 2010

(51) Int. Cl. B65D 43/08; F16L 5/00

(52) U.S. Cl. 220/796; 16/2.1

(57) ABSTRACT

A sealing system having a grommet configured to be disposed within a grommet cap, the grommet cap configured to be disposed in an aperture formed between an enclosure top having a first tongue, and an enclosure base having a second tongue, and wherein the grommet cap is configured to cover a portion of the grommet, and wherein said grommet cap comprises two walls configured to form a channel, said channel configured to receive said first and second tongues.

### BACKGROUND OF THE INVENTION

1. Field of the Invention

The field of the invention relates to enclosures generally, and more particularly to certain new and useful advances in sealed enclosures and sealing systems of which the following is a specification, reference being had to the drawings accompanying and forming a part of the same.

2. Description of Related Art

Conventional electronics modules and/or systems generally comprise various electronics components which are attached to printed circuit boards and which may be disposed in an electronics enclosure to protect the electronics devices. The printed circuit boards provide support for electrical connections to the various electronics components attached thereto.

Conventional electronic modules and/or systems may be housed in separate enclosures which are typically connected to one another by one or more lines configured to carry electrical signals between the electronic modules and/or systems. The lines typically comprise conductive wires or cables having a connector at each end which are configured to be connected to the printed circuit boards located inside the electronics enclosure.

The enclosures housing conventional electronic modules and/or systems are frequently of a “split-box” design, comprising an enclosure top and an enclosure base, which may be hinged or separately configured to mate along an interface surface to form an interior cavity. Additionally, such enclosures conventionally comprise apertures or feed-through openings configured to allow the lines or cables to pass through the enclosure. It is frequently necessary that the interior of the enclosure be sealed from the ambient environment along the interface surface, as well as at any cable feed-through openings, in order to provide environmental protection, such as protection from ingress of an ambient fluid medium such as moisture or other liquids. Many methods, devices and systems have been used to provide a protective seal, including gaskets or grommet seals.

With reference to FIGS. 1A-1E, a various views of a conventional enclosure 100 of a conventional sealing system known in the art is shown. An enclosure base 120 of enclosure 100 has a sidewall 122 with an interface surface 125 arranged to mate along a portion of a corresponding interface surface 115 on sidewall 111 of enclosure top 110. Sidewall 122 typically includes a first notched portion 123 configured to align with a corresponding second notched portion 113 on sidewall 111 of enclosure top 110 to form an aperture 130 in order to enable feed through of one or more cables (not shown) into enclosure 100. A first tongue 124 having an outer surface 124a and an inner surface 124b may be disposed on enclosure base. A second tongue 114 having an outer surface 114a and an inner surface 114b may be disposed on enclosure top, with each tongue 124, 114 extending generally orthogonal to the respective sidewalls 122, 111. A grommet, such as single-piece grommet 141, is typically disposed in aperture 130.

While grommet 141 is shown in FIGS. 1A-1E, to have a generally rectangular cross-section, conventional grommets are known to have various shapes and cross-sections generally corresponding to the shape of aperture 130. Such grommets 141 conventionally have a body portion 144 comprising at least one peripheral rib 142 configured to be disposed within aperture 130 and to engage the inner surfaces 124b, 114b of tongues 124, 114, typically under a compressive force between enclosure top 110 and base 120 in order to provide a seal. It is typically necessary that a conventional grommet 141 be compressed between enclosure top 110 and base 120 in order to provide an effective seal.

Conventional grommets 141 also have one or more openings 144a through which a corresponding cable (not shown) may be passed.

Additionally, a grommet cap 180 having a single peripheral outer wall 181 and an outer face 182 is conventionally provided to protect and retain the grommet 141. The single peripheral outer wall 181 comprises an inner surface 181a and an outer surface 181b and is configured to be disposed over the first and second tongues 124, 114, such that inner wall surface 181a is adjacent to the outer tongue surfaces 124a, 114a, and outer face 182 is disposed adjacent to outer face surface 145 of grommet 141. The face surface 182 of grommet cap 180 may be provided with one or more openings 184a therethrough, corresponding to the respective one or more grommet openings 144a and through which a cable (not shown) may likewise be passed.

Often, to compensate for surface irregularities along interface the surfaces 125, 115, and to compensate for expansion and contraction of enclosure top 110 and base 120, a gasket, or a sealant material, such as RTV silicon is disposed between the interface surfaces 125, 115 to further aid in sealing the enclosure 100.

In conventional enclosures, a well-formed interface between grommet 141 and the surfaces 125, 115 at the notched portion of enclosure 100 is required to enable effective sealing against moisture ingress proximal to the first and second tongues 124, 114.

Conventional sealing methods and devices have not been entirely satisfactory, for example for preventing leakage after the enclosure has been subjected to high temperature over an extended operating interval, followed by a cool-down interval. For at least the reasons stated above, a need exists for an improved enclosure and sealing system.

### BRIEF SUMMARY OF THE INVENTION

One or more specific embodiments shown and/or described herein address at least the above-mentioned need.

In an embodiment, a cap is disclosed, the cap comprising a first outer wall having a first length L1, a second inner wall having a second length L2, said second inner wall being spaced apart from said first outer wall.

In another embodiment an enclosure is disclosed, the enclosure comprising a base comprising a first sidewall, said first sidewall including a first notched portion, a first tongue disposed on said first sidewall, a top comprising a second sidewall, said second sidewall comprising a second notched portion, a second tongue disposed on said second sidewall, said first notched portion being configured to align with said second notched portion to form an aperture disposed between said base and said top, a grommet cap comprising: a first outer wall having a first length L1; a second inner wall having a second length L2 and arranged to form a cavity, said second inner wall being spaced apart from said first outer wall; and a channel disposed between said first outer wall and said second inner wall, said channel being configured to receive said first and second tongues, and a grommet configured to be received within said cavity.

In yet another embodiment, a sealing system is disclosed, the system comprising an enclosure, the enclosure comprising a base comprising a first sidewall, said first sidewall including a first notched portion, a first tongue disposed on said first sidewall, a top comprising a second sidewall, said second sidewall comprising a second notched portion, a second tongue disposed on said second sidewall, said first notched portion being configured to align with said second notched portion to form an aperture disposed between said base and said top, a grommet cap comprising: a first outer wall having a first length L1; a second inner wall having a second length L2 and arranged to form a cavity, said second inner wall being spaced apart from said first outer wall; and a channel disposed between said first outer wall and said second inner wall, said channel being configured to receive said first and second tongues, and a grommet configured to be received within said cavity.

Apparatus and systems of varying scope are shown and described herein. In addition to the advantages described above, further advantages and/or adaptations or variations will become apparent by reference to the drawings and by reading the remaining portions of the specification.

### BRIEF DESCRIPTION OF THE DRAWINGS

Reference is now made briefly to the accompanying drawings, in which:

FIGS. 1A and 1B illustrate exploded views of a prior art sealing system;

FIG. 1C illustrates a top view of a prior art sealed enclosure;

FIG. 1D illustrates an end view of the prior art enclosure of FIG. 1C;

FIG. 1E illustrates a section view of the prior art enclosure of FIG. 1D looking in the direction A-A;

FIG. 1F illustrates a magnified view of a portion of the prior art enclosure of FIG. 1E;

FIG. 1G illustrates a partial section view of the prior art enclosure of FIG. 1E;

FIGS. 2-4 illustrate exploded views of a an embodiment;

FIGS. 2-4 illustrate exploded views of an embodiment of the present invention;

FIG. 5 illustrates a perspective view of an embodiment of the grommet cap of FIG. 3;

FIG. 6 illustrates a magnified view of a portion of an embodiment of FIG. 4;

FIG. 7 illustrates an end view of an embodiment;

FIG. 8 illustrates a section view of the embodiment of FIG. 7 looking in the direction B-B; and

FIG. 9 illustrates a magnified view of a portion of the embodiment of FIG. 8; and

FIG. 10 illustrates an exploded view of an embodiment.

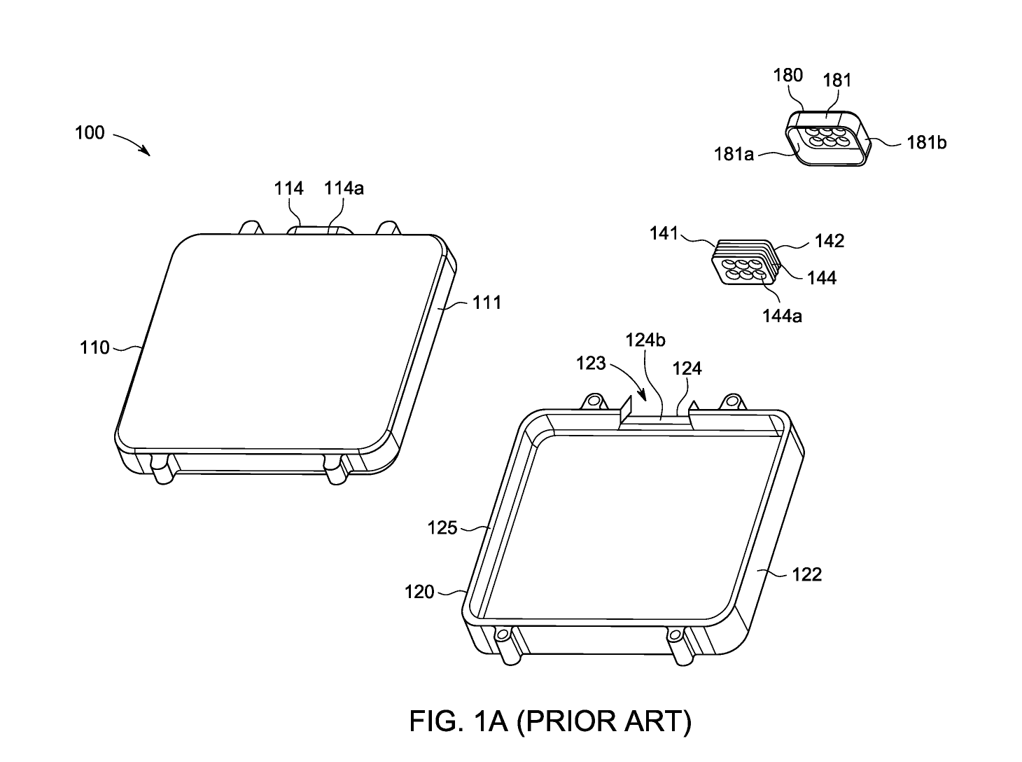

Like reference characters designate identical or corresponding components and units throughout the several views, which are not to scale unless otherwise indicated.

### DETAILED DESCRIPTION OF THE INVENTION

The following description makes reference to the accompanying drawings that form a part hereof, and in which is shown by way of illustration specific embodiments that may be practiced. It is understood that other embodiments may be utilized and that various changes can be made to the embodiments shown and described herein without departing from the patentable scope of the claims appended hereto. The following description is, therefore, not to be taken in a limiting sense.

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

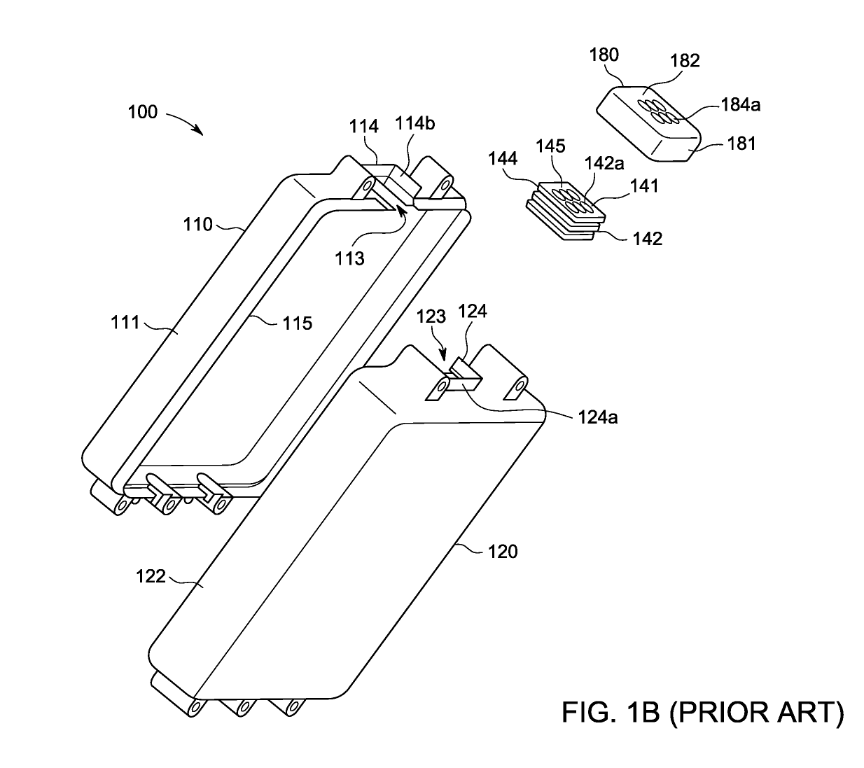

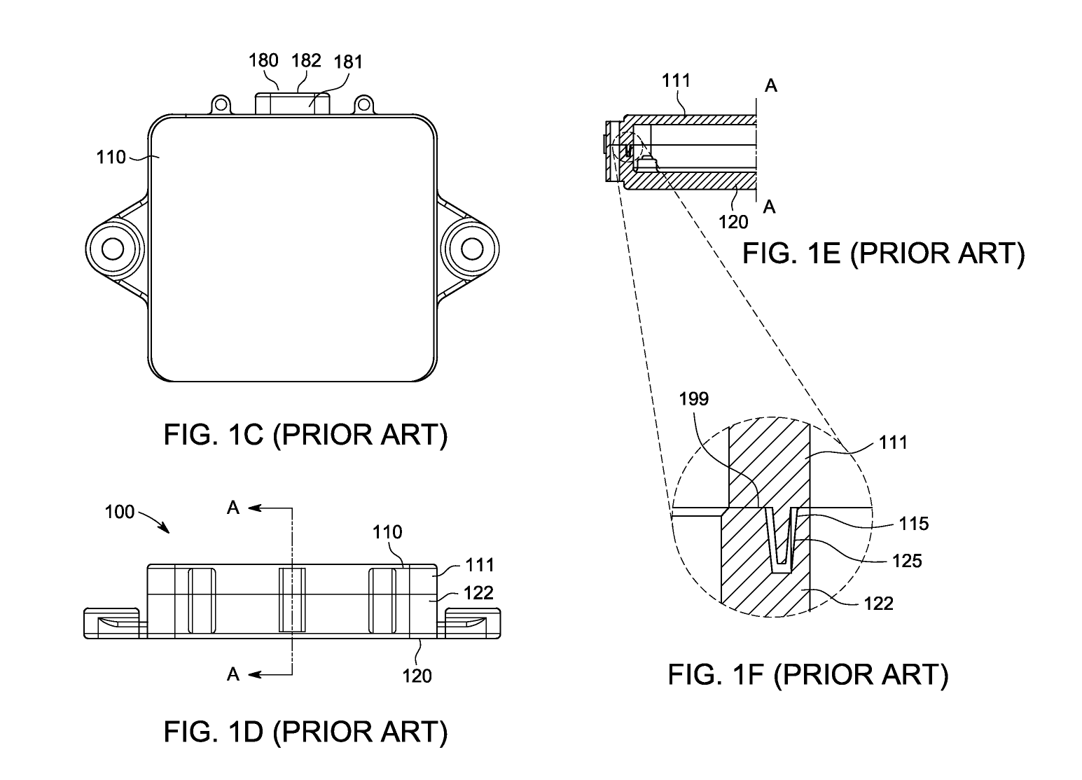

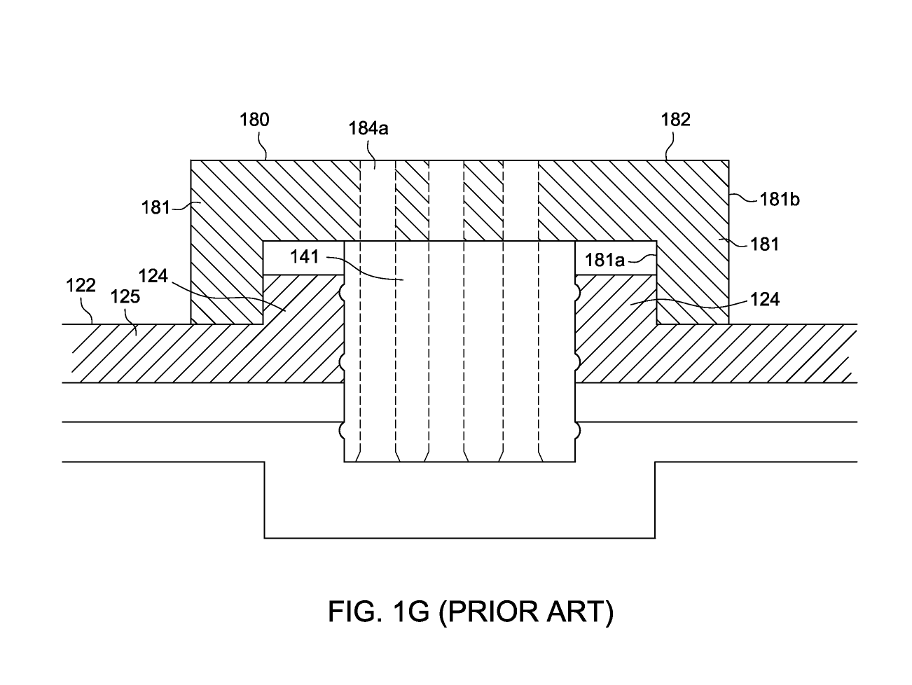

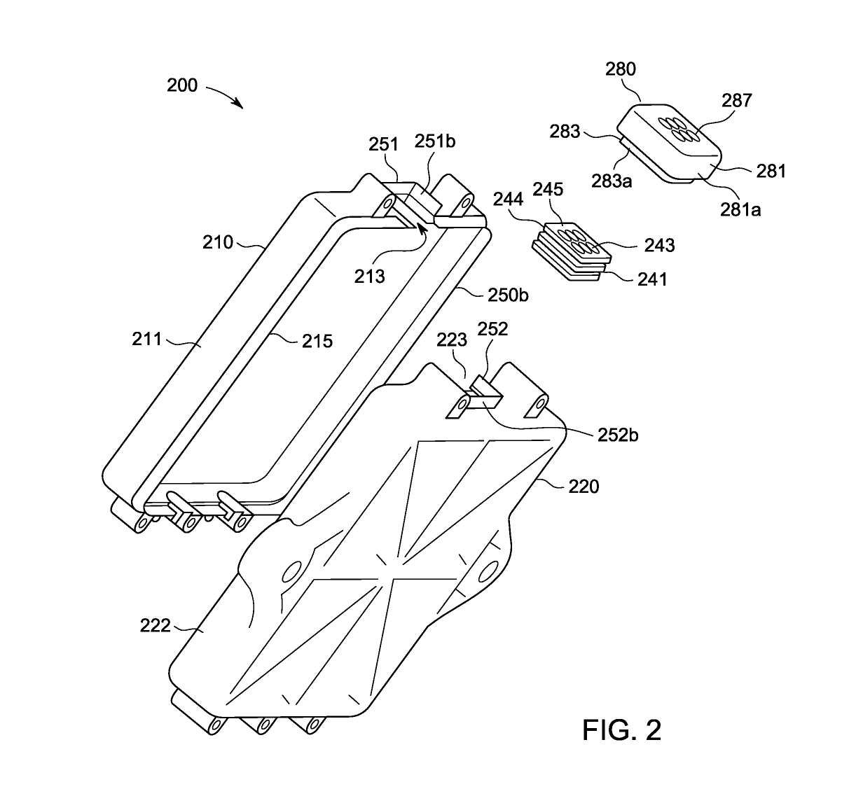

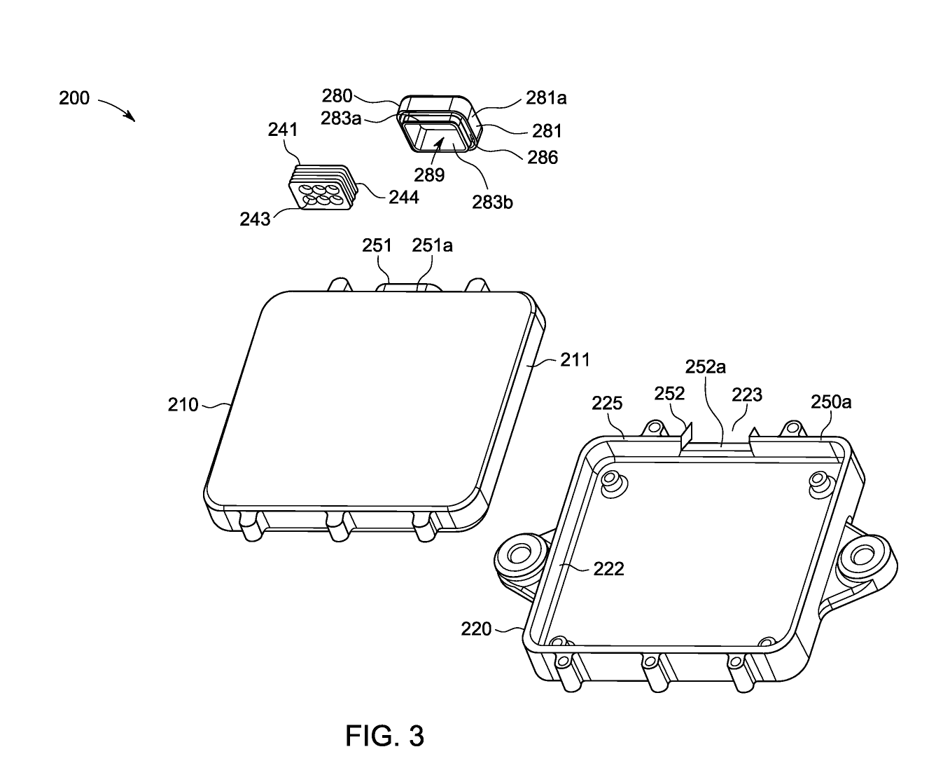

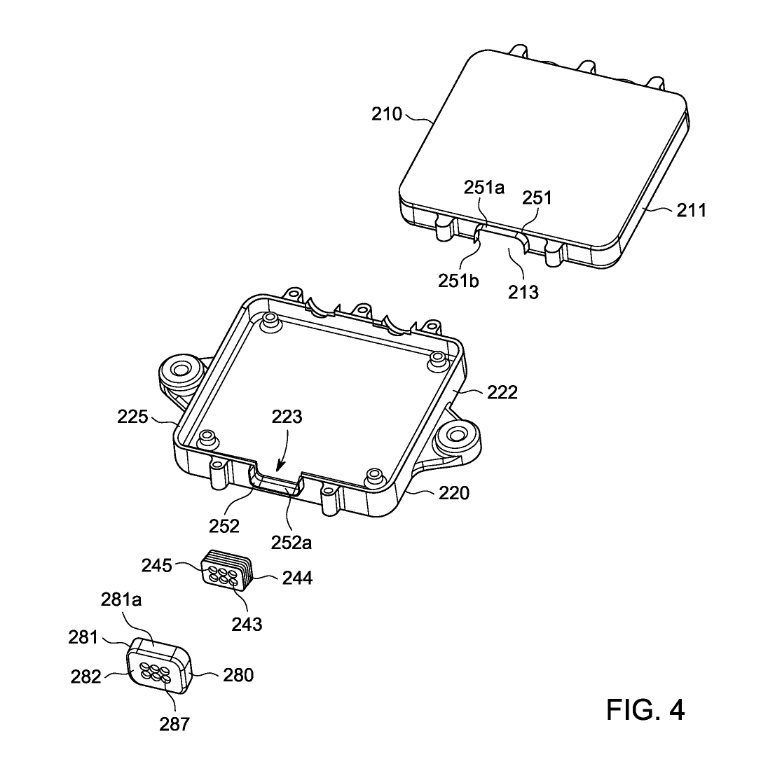

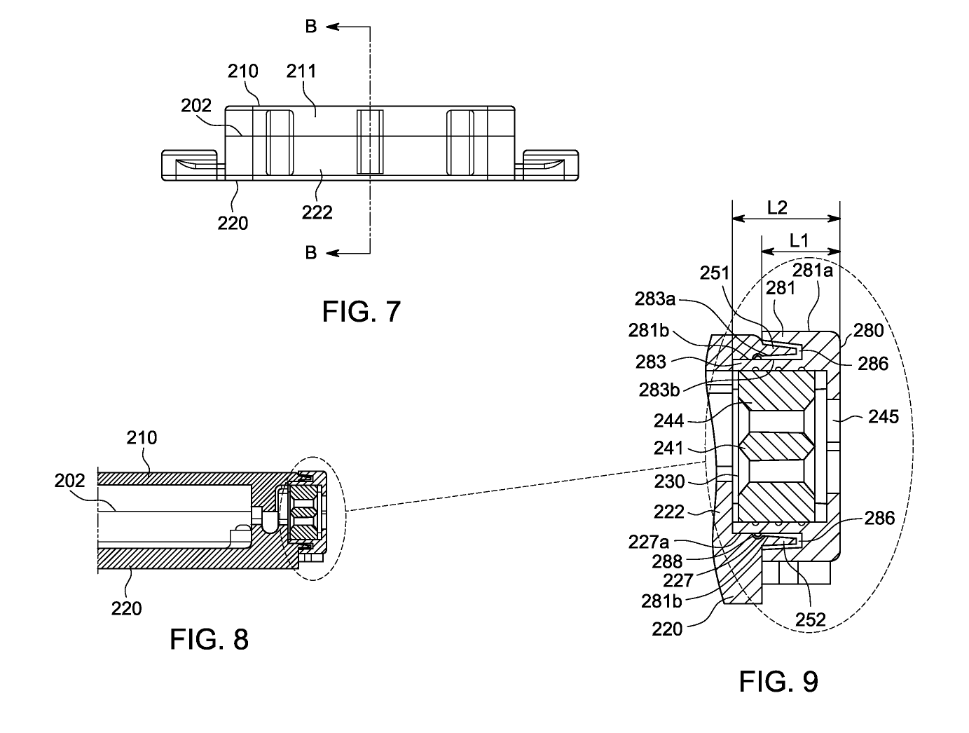

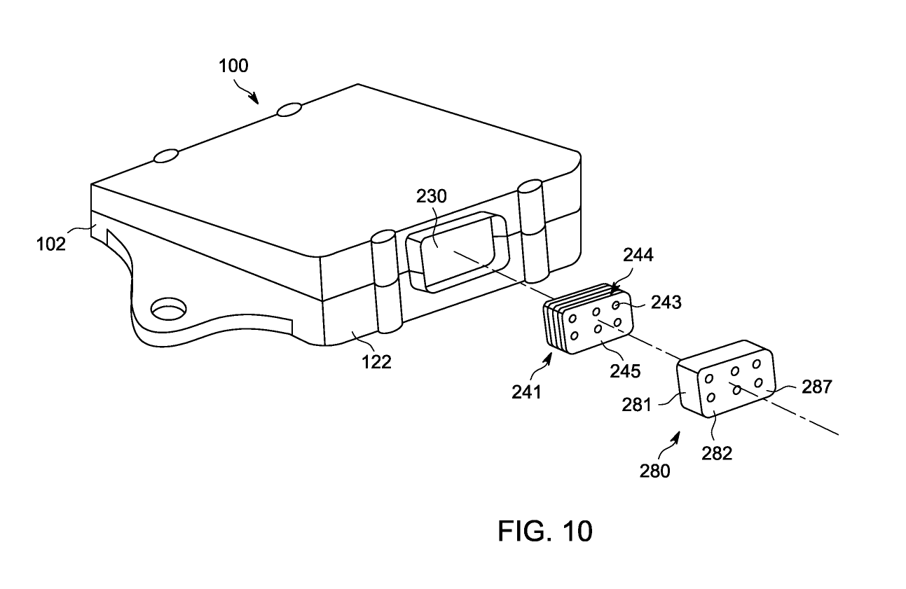

With reference to FIGS. 2-4, 7, and 9, illustrations of an embodiment are shown in exploded view. Enclosure base 220 of enclosure 200 comprises a first sidewall 222 having a first interface surface 250a configured to mate with a corresponding portion of a second interface surface 250b on a second sidewall 211 of enclosure top 210 to form a seam 202 (Ref. FIG. 7). First sidewall 222 further comprises a first notched portion 223 (Ref. FIG. 4) configured to generally align with a corresponding second notched portion 213 on second sidewall 211 of enclosure top 210 to form an enclosure aperture 230 (Ref. FIG. 9) disposed between the enclosure top 210 and base 220. Enclosure aperture 230 is configured to receive at portion of a grommet cap 280 (FIG. 5). A first tongue 252, having a first inner surface 252a and an first outer surface 252b, is disposed on enclosure base 220, and a second tongue 251, having a second outer surface 251a and a second inner surface 251b, is disposed on enclosure top 210, with the first and second tongues 251, 252 preferably extending generally orthogonal to the respective sidewalls 211, 222.

A grommet 241 is provided, having a body portion 244 configured to be disposed within a grommet cap 280 and preferably formed of flexible elastomeric material such as silicone rubber or urethane. Body portion 244 of grommet 241 preferably comprises at least one peripheral sealing rib 242. While grommet 241 is shown in the figures to have a generally rectangular cross-section, in various embodiments, the grommet 241 may be configured in various shapes, geometries, and cross-sections generally corresponding to the shape of grommet cap cavity 289. In an embodiment, the outer face surface 245 of grommet 241 comprises one or more openings 243 through which a corresponding cable (not shown) may be passed.

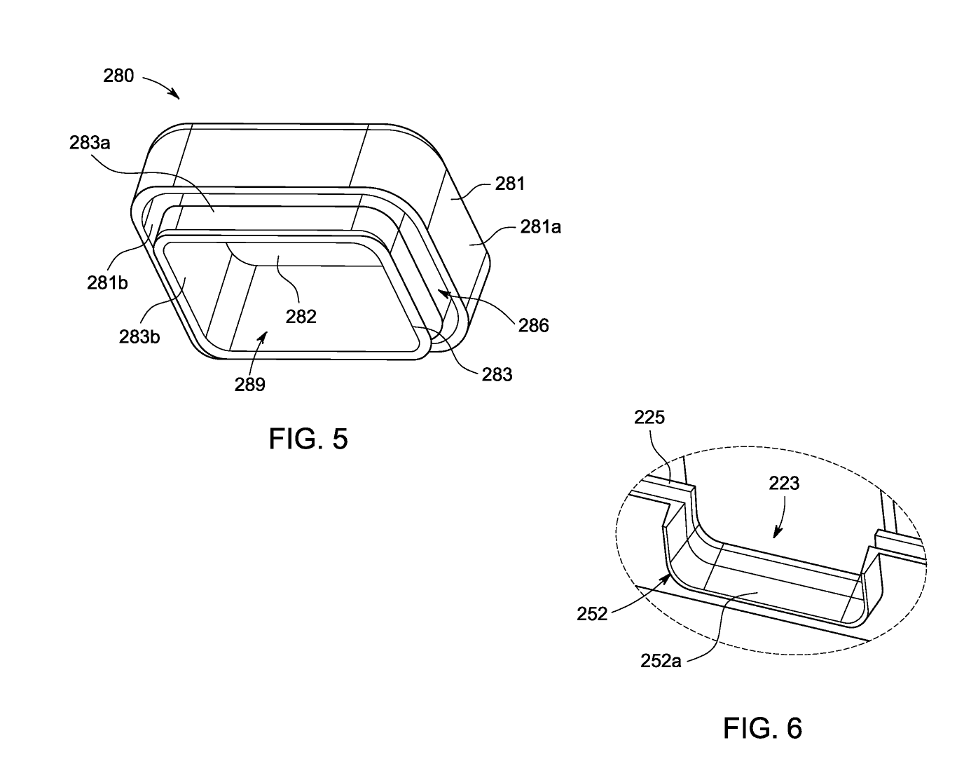

With reference to FIGS. 4, 5, 8, and 9, the grommet cap 280 is configured to cooperate with the first and second tongues 252, 251 and disposed to cover grommet 241. Grommet cap 280 comprises a first outer sealing wall 281 having a first length L1, a first outer sealing wall outer surface 281a, and a first outer sealing wall inner surface 281b. Grommet cap 280 additionally comprises a second inner sealing wall 283 having a second length L2, a second inner sealing wall outer surface 283a, and a second inner sealing wall inner surface 283b. The second inner sealing wall 283 is arranged to define a cavity 289 configured to receive grommet 241. In an embodiment, the second inner sealing wall 283 is further configured to be received within the enclosure aperture 230. In an embodiment, the second inner sealing wall surface 283b provides an uninterrupted surface configured to engage the at least one peripheral rib 242 of grommet 241. In an embodiment, the first length L1 of the first outer sealing wall 281 is less than the second length L2 of the second inner sealing wall 283. The first outer sealing wall 281 and the second inner sealing wall 283 are spaced apart to form a channel 286. The channel 286 is dimensioned to receive the first and second tongues 252, 251. Grommet cap 280 additionally comprises a third face wall 282, preferably oriented generally orthogonal to channel 286 and configured to be disposed over outer face surface 245 of grommet 241. Grommet cap 280 is configured to be disposed over a portion of grommet 241 such that the second inner sealing wall 283 is disposed between grommet 241 and the tongues 252, 251 of the enclosure base 220 and top 210. Grommet cap 280 thereby prevents grommet 241 from contacting the seam 202, mating surfaces 250a, 250b, and tongues 252, 251 of the enclosure base 220 and top 210 to more effectively seal the enclosure 200.

In an embodiment, grommet cap 280 is provided with one or more openings 287 through the face surface 282, preferably corresponding to the grommet openings 243, and through which one or more cables (not shown) may be passed.

In an embodiment, an adhesive sealant material (not shown), such as room temperature vulcanizing RTV silicone rubber, may be disposed between at least one of the first and second tongues 251, 252 and at least one of the first outer wall 281 and second inner wall 283 to provide a seal with grommet cap 280 to further protect against moisture ingress into enclosure 200.

In an embodiment, a portion of the second inner sealing wall outer surface 283a of grommet cap 280 is configured to engage the first notched surface portion 223 of first sidewall 222 and the second notched surface portion 213 on second sidewall 211. In an embodiment, the first notched surface portion 223 of sidewall 222 is provided with at least one engagement feature, such as for example a groove 227 configured to cooperate with an engagement rib 288 disposed on the first outer sealing wall outer surface 281 to provide a retention force against grommet cap 280.

This specification, including the claims, abstract and drawings, is intended to cover any adaptations or variations of the specific embodiments illustrated and described herein. Accordingly, the names of elements, components or features, of the above-described system, methods, and apparatus are not intended to be limiting. It is contemplated that the above-described embodiments, whether adapted or varied or not, are applicable to future enclosure apparatus and systems. Moreover, the terminology used herein is intended to encompass all enclosures and systems that provide the same or equivalent functionality described herein.

Although effort was made to show all of the particular elements, components or features of each of the above-described specific embodiments in separate figures, this may not have been possible. In the event that one or more elements, components or features of one or more of the above-described specific embodiments are shown in some drawings and not in others, it is contemplated that each element, component or feature of one drawing may be combined with any or all of the other elements, components or features shown in any or all of the remainder of the drawings, as described herein, as claimed herein or in any other suitable fashion.

The words “including”, “comprising”, “having”, and “with” as used herein are to be interpreted broadly and comprehensively and are not limited to any physical interconnection. Additionally, patentable scope is defined by the following claims, which are intended to encompass not only the specific embodiments described above, but also adaptations or variations thereof (i) that have structural elements that do not differ from the literal language of the claims, or (ii) that have equivalent structural elements with insubstantial differences from the literal language of the claims.

What is claimed is:

1. A grommet cap 280 comprising:
a first outer wall 281 having a first length L1; and
a second inner wall 283 having a second length L2, said second inner wall being spaced apart from said first outer wall 281.

2. The cap 280 of claim 1 further comprising:
a channel 286 disposed between said first outer wall 281 and said second inner wall 283.

3. The cap 280 of claim 1 wherein:
said second inner wall 283 is arranged to form a cavity 289.

4. The cap 280 of claim 1 wherein:
said first outer wall 281 is generally parallel to said second inner wall 283.

5. The cap 280 of claim 1 further comprising a third face wall 282 arranged to couple said first outer wall 281 and said second inner wall 283.

6. The cap 280 of claim 1 wherein:
the first length L1 of the first outer wall 281 is less than the second length L2 of the second inner wall 283.

7. The cap of claim 1 wherein:
said third face wall 282 is generally orthogonal to said second inner wall 283.

8. An enclosure 200, comprising:
a base 220 comprising a first sidewall 222, said first sidewall 222 including a first notched portion 223;
a first tongue 252 disposed on said first sidewall 222;
a top 210 comprising a second sidewall 211, said second sidewall 211 comprising a second notched portion 213;
a second tongue 251 disposed on said second sidewall 211;
said first notched portion 223 being configured to align with said second notched portion 213 to form an aperture 230 disposed between said base 220 and said top 210;
a grommet cap 280 comprising:
a first outer wall 281 having a first length L1;
a second inner wall 283 having a second length L2 and arranged to form a cavity 289, said second inner wall 283 being spaced apart from said first outer wall 281; and
a channel 286 disposed between said first outer wall 281 and said second inner wall 283, said channel 286 being configured to receive said first and second tongues 251, 252; and
a grommet 241 configured to be received within said cavity 289.

9. The enclosure of claim 8, wherein
said first sidewall 222 further comprises a first interface surface 250a;
said second sidewall 211 comprises a second interface surface 250b; and
wherein said first interface surface 250a is configured to mate with at least a portion of said second interface surface 250b.

10. The enclosure of claim 8, wherein:
said first tongue 252 is disposed generally orthogonal to said sidewall 222; and
said second tongue 251 is disposed generally orthogonal to said sidewall 211.

11. The enclosure of claim 8, wherein the first length L1 of said first outer wall 281 is less than the second length L2 of said second inner wall 283.

12. The enclosure of claim 8, wherein said grommet cap 280 further comprises a third face wall 282 arranged to couple said first outer wall 281 and said second inner wall 283.

13. The enclosure of claim 8, wherein
said first notched surface portion 223 of sidewall 222 comprises an engagement feature 227 configured to provide a retention force against grommet cap 280.

14. The enclosure of claim 13, wherein the engagement feature 227 is an engagement rib.

15. A sealing system comprising:
an enclosure 200, said enclosure 200 comprising a base 220 and a top 210;
said base 220 comprising a first sidewall 222, said first sidewall 222 comprising a first notched portion 223;
a first tongue 252 disposed on said first sidewall 222;
said top 210 comprising a second sidewall 211, said second sidewall 211 comprising a second notched portion 213;
a second tongue 251 disposed on said second sidewall 211;
said first notched portion 223 being configured to align with said second notched portion 213 to form an aperture 230 disposed between said base 220 and said top 210;
a grommet cap 280 configured to cover a portion of the grommet 241, said grommet cap 280 comprising:
a first outer wall 281 having a first length L1;
a second inner wall 283 having a second length L2 and arranged to form a cavity 289, said second inner wall 283 being spaced apart from said first outer wall 281; and
a channel 286 disposed between said first outer wall 281 and said second inner wall 283, said channel 286 being configured to receive said first and second tongues 251, 252; and
a grommet 241 configured to be received within said cavity 289.

16. The sealing system of claim 15, wherein:
said first sidewall 222 further comprises a first interface surface 250a;
said second sidewall 211 comprises a second interface surface 250b; and
wherein said first interface surface 250a is configured to mate with at least a portion of said second interface surface 250b.

17. The sealing system of claim 15, wherein:
said first tongue 252 is disposed generally orthogonal to said first sidewall 222; and
said second tongue 251 is disposed generally orthogonal to said second sidewall 211.

18. The sealing system of claim 15, wherein the first length L1 of said first outer wall 281 is less than the second length L2 of said second inner wall 283.

19. The sealing system of claim 15, wherein said grommet cap 280 further comprises a third face wall 282 arranged to couple said first outer wall 281 and said second inner wall 283.

20. The sealing system of claim 15, wherein
said first notched surface portion 223 of sidewall 222 comprises an engagement feature 227 configured to provide a retention force against grommet cap 280.
